(19) United States
(12) Patent Application Publication
(10) Pub. No.: US 2006/0185744 A1
(43) Pub. Date: Aug. 24, 2006

(54) Fitting for liquids

(75) Inventor: Willi Hecking, Niederkruechten-Elmpt (DE)

Correspondence Address: THORPE NORTH & WESTERN, LLP., 8180 SOUTH 700 EAST, SUITE 200, SANDY, UT, 84070, US

(73) Assignee: Hans Sasserath & Co KG, Korschenbroich (DE)

(21) Appl. No.: 11/323,188

(22) Filed: Dec. 29, 2005

(30) Foreign Application Priority Data
Dec. 29, 2004 (DE) 10 2004 063 747.4
Mar. 2, 2005 (DE) 102005 010 139.9
Jul. 5, 2005 (EP) 05 014 511.9

(51) Int. Cl. F17D 1/08

(52) U.S. Cl. 137/613

(57) ABSTRACT

A fitting assembly for liquids adapted to be installed in a pipeline includes an inlet and first shut-off governing said inlet, an outlet and second shut-off governing said outlet, and components which require occasional or regular servicing arranged in a flow path between said first and second shut-offs. The said fitting assembly comprises a first fitting part adapted to be fixedly installed in said pipeline by means of said first and second shut-offs, said first fitting part having first and second connections between said first and second shut-offs, said fitting assembly comprises a second fitting part, said second fitting part containing the components which require occasional or regular servicing, and a means for removably attaching said second fitting part to said connecting means of said first fitting part.

### BACKGROUND OF THE INVENTION

1. Field

The invention relates to an armature for liquids for the installation in a pipe for liquids comprising an inlet passage for liquids which is adapted to be shut off by first shut-off means and an outlet passage for liquids which is adapted to be shut off by second shut-off means and one or more components in need of servicing which are positioned between said first and second shut-off means.

Such components in need of servicing may be, in particular, filters, backflow preventers, pipe disconnectors, pressure reducers and any other valves as they may be used in water armatures in various embodiments and arrangements for various purposes.

Examples for such a water armature are pipe disconnector armatures or safety assemblies for protecting drinking water heaters.

2. State of the Art

A safety assembly for protecting drinking water heaters normally comprises a housing, an inlet and an outlet, a flow passage between inlet and outlet, an outlet and a backflow preventer arranged in the flow passage. The backflow preventer prevents the backflow of water from the outlet to the inlet.

Such a safety assembly is used for drinking water heaters. Drinking water heaters are normally heat-insulated containers. The container is connected to the drinking water system on one side and to the house water system on the other side. The house water system is provided with taps for heated drinking water. The heating of the drinking water is effected by means of a heat exchanger which is operated with hot heating water from a hot water heating. If the water comprised in the drinking water heater is heated up it expands. An overpressure is generated. Furthermore it must be ensured, that no water from the drinking water heater can flow back into the drinking water system.

Therefore a safety assembly is installed upstream of the drinking water heater. Such a safety assembly comprises a safety valve through which water can be released and the pressure can be reduced if a given pressure in the drinking water heater is exceeded, by, for example, heating and thermal expansion of the water. Furthermore, a valve in the form of a backflow preventer is provided. The backflow preventer practically is a check valve allowing a water flow only in one direction, i.e. from the drinking water system towards the drinking water heater, but it prevents the backflow from the drinking water heater into the drinking water system. Furthermore a shut-off valve is usually provided on the inlet side of the safety assembly.

The backflow preventer must be regularly serviced. Therefore, it is arranged between shut-off valves. For servicing purposes the shut-off valves can be closed and the backflow preventer is removed.

Safety assemblies are known, where the expansion water is not disposed of through an outlet but flows into an expansion tank. The expansion tank is provided with a membrane on its inside, which is exposed to gas pressure. If the water pressure exceeds the pre-adjusted gas pressure, the water flows into the expansion tank. If the water pressure drops again, the water flows back into the heating circuit. The expansion tanks have the largest receiving volume if the water pressure corresponds to the pre-adjusted gas pressure. If the water pressure increases, for example due to pressure fluctuations in the supply line, the expansion tank is filled before heating already. It is not the entire expansion volume available anymore. It is, therefore, reasonable to provide a pressure reducer upstream of the expansion tank for safety assemblies with an expansion tank. The pressure reducer guarantees a uniform water pressure and thus ensures the full efficiency of the expansion tank.

Different safety assemblies are used for different purposes. There are safety assemblies with expansion tanks for different pressure ranges, for example for up to 6, 8 and 10 bar. Furthermore, there are safety assemblies without any expansion tank, where the expansion water is disposed of by flowing through a safety valve into a dropping funnel. Safety assemblies with an expansion tank which are used in installations without a pressure reducer are provided with a pressure reducer. Often a dirt trap or a filter is used.

An example for such a safety assembly is disclosed in the DE 103 12 527.2. The assembly described therein is provided with a backflow preventer as a component in need of servicing which is installed in the form of a cartridge in the assembly.

The water armature may also be a pipe disconnector. A pipe disconnector is used to separate a drinking water system from a service water system. The service water system may be, for example, a heating system. Such a heating system is filled up or re-filled from a drinking water system, the drinking water supply. It has to be ensured, at all events, that water does not flow from the service water system back into the drinking water system, for example, in the case of a pressure drop in the drinking water system. To this end, backflow preventers are provided. They are spring-loaded check valves which under the influence of the drinking water pressure open only in the direction from the drinking water system towards the service water system. For continuous operation, however, this is also not regarded as sufficient. Rather is a physical separation between the drinking water system and the service water system prescribed, for example by filling or re-filling through a hose which is removed, after the filling or re-filling process has been completed. This ensures that no service water can get into the drinking water system even in the case of leaking shut-off valves or backflow preventers.

As the removal of the hose after the filling or re-filling process is troublesome and, in addition, cannot be checked, fixed installations of pipe disconnectors are known (for example EP 0,972,995 A1). These known pipe disconnectors comprise an upstream backflow preventer, i.e. a backflow preventer installed on the side of the drinking water system, and a downstream backflow preventer, i.e. a backflow preventer installed on the side of the service water system. Both backflow preventers open in the direction towards the service water system. A pressure controlled relief valve is provided between the backflow preventers. This relief valve is controlled by the drinking water pressure and opens automatically, when the drinking water pressure breaks down or drops. Thus, if the service water system is filled or re-filled and a service water pressure sufficient therefor is present, then the relief valve is closed by this pressure. Drinking water flows through the backflow preventer pushed open by the drinking water pressure and into the service water system.

If the drinking water pressure drops below a predetermined level, either because a shut-off valve shuts off the drinking water system or because the drinking water pressure breaks down for one reason or other, the relief valve will open. Even if then service water flows back from the service water system through a leaking backflow preventer, this service water flowing back is drained through the outlet and, by no means, can get into the drinking water system.

From the printed company publication “SYR Füllgruppe Typ 2128” of the Hans Sasserath & Co. KG a filling assembly is known, which is fixedly installed to the service water system, for example a closed heating system, and which is provided with a connection for a hose. The filling assembly is connected to the drinking water system by this connection hose. The filling assembly comprises a shut-off valve and a pressure reducer.

A pipe disconnector assembly is described in the DE 103 08 838.5, wherein a backflow preventer is removable from the pipe disconnector housing together with a relief valve as a whole in one assembly.

The known armatures are fixedly incorporated in the pipe. For servicing the shut-off valves must be closed and the armature disassembled from the pipe. This is time-consuming.

From the printed company publication GEOH-1353GE23 R0205 of Honeywell GmbH, D-74821 Mosbach (www.honeywell.de/haustechnik) a connection combination for connecting a safety assembly and a membrane pressure expansion tank is known under the name MAG160S. The connection combination is a one-piece formation. The expansion tank is provided directly at the connection combination. A separate pressure reducer can be provided upstream of the connection combination in the pipe. If the pressure reducer is serviced, it must be removed from the installation. The installation with and without pressure reducer have different installation sizes. If the requirements for the safety assembly change the installation must be adapted accordingly. This is time- and money-consuming.

### SUMMARY OF THE INVENTION

It is an object of the invention to provide a water armature of the above mentioned kind, which is more compact, easier to replace and to service and which provides for an easier storage management.

According to the invention this object is achieved by a first armature part which is fixedly incorporated in the pipe, provided with said first and said second shut-off means and wherein two connections are provided between said first and said second shut-off means whereto a second armature part is removable attachable, wherein the component in need of servicing is removable from the first armature part together with the second armature part.

Thus, the armature is formed by a two-part armature. By simply actuating the shut-off means the second armature part can be removed and serviced or replaced. The advantage is that the installation in the pipe is the same at all times. The installation in the pipe does not have to be broken when installing or removing components. The installation sizes are the same, regardless whether an armature with or without a pressure reducer is installed.

It is particularly advantageous, that the mode of operation of the armature can be changed without changing the installation. A simple armature may be replaced by a more complex armature with more functions, for example, an additional pressure reducer, filter, expansion tank or the like. The storage management is also simplified. Instead of providing an individual device for each pressure and each mode of operation it is sufficient for a safety assembly, for example, to provide a connection part which is the same for all modes of operation and a suitable second armature part for each mode of operation. The latter are smaller and cheaper, whereby the storage management is simplified. The safety valve block is always the same.

The armature as a whole may be shorter, too. By using a modular set up an extendable construction kit is generated. The shut-off means are commonly used by all components, for example pressure reducers, expansion tank, backflow preventer, etc. The armature, therefore, only requires particularly few components.

Preferably the connections for connecting the second armature part are formed by two parallel connection necks. Thereby the second armature part may be connected to the first armature part directly to the corresponding connection necks or other connections, for example by inserting and screwing.

Preferably the liquid inlet and the liquid outlet are in alignment, thereby defining a longitudinal armature axis. The axes of the connection necks run perpendicular to such longitudinal axis. The armature may then be installed in a linear pipe without an additional adapter. The connection necks extend perpendicular from the pipe enabling the installation directly at a wall.

In a further modification of the invention the shut-off means are formed by ball valves. The ball valves can be positioned in such a way, that the inlet for the liquid and the outlet for the liquid on one hand and the corresponding connection necks on the other hand may be shut off and that with the ball valve in an opened position the liquid flows with an angle through the ball valve from the inlet to the first connection and from the second connection with an angle through the ball valve to the outlet, respectively. The ball valve, therefore, shuts off the inlet or outlet, respectively as well as the connection neck.

In a preferred embodiment of the invention the ball valve of the first shut off means is provided with a rotating actuating element for opening and closing the flow path, which is designed in such a way, that the rotational angle between its to end positions is at least 180°, preferably 270°. Thereby a sudden change of the volume flow with the corresponding pressure shock at the valve is avoided.

This can preferably effected by the ball of the ball valve rotating about an axis is provided with an annular groove with a decreasing cross section along the circumference outside of this axis. With this embodiment there is no need for a complex gearing at the actuating element. The groove in the ball, for example, lets a part of the flow still flow when the valve is closed. The valve shuts of with a much reduced pressure shock.

A pressure reducer may be provided in the second part of the liquid armature. This is useful if components are used, for example an expansion tank, which operate more effectively at constant pressure or if there is no further pressure reducer provided in the installation.

Furthermore a dirt trap or a filter may be provided in the second armature part. These can be well disassembled with the second armature part and may then easily be cleaned, replaced or serviced. One or more backflow preventers can be provided in the second armature part, also. Such backflow preventers require shut-off valves for test purposes. The backflow preventers are, furthermore, easily accessible for the prescribed service and test.

In a further modification of the invention the liquid armature is a pipe disconnector assembly. The pipe disconnector assembly preferably has the features as claimed in claim 13.

Connection means each having a connection neck which is aligned with the inlet or the outlet, respectively, of the armature housing and forming an angle with the axis of the pipe can be installed in the pipe for installing the armature housing in the pipe. The armature housing is then arranged on the side of the pipe.

Preferably this is effected in such a way that a connection piece is provided as a connection means for installing the armature housing in the pipe, said connecting piece being mounted into the pipe with an inlet neck and an outlet neck. A shut-off valve can be installed downstream of the inlet neck. Downstream from this shut-off valve a connection neck may be provided which is adapted to be connected in alignment with the inlet of the armature housing. The outlet neck of the connection piece can only be connected with a connection neck which is adapted to be connected in alignment with the outlet of the armature housing. The inlet neck of the connection piece can be connected, on one hand, to the shut-off valve and the connection neck downstream thereof and, on the other hand, the outlet neck can be connected can be connected to the connection neck connected thereto by a non-flow guiding distance piece.

The armature housing can have a longitudinal-prismatic basic shape and define a longitudinal axis. The liquid inlet and liquid outlet can be formed by connection necks with axes running perpendicular to said longitudinal axis.

The pipe disconnector can be, if necessary, accessible from both sides in the direction parallel to the pipe in an armature housing which is arranged on the side of the pipe. It is not necessary to provide a bore hole for receiving the pipe disconnector with an angle with respect to the axis of the pipe as it is the case in the DE 103 08 838 A1, where the pipe disconnector is accessible from one side only.

In an alternative embodiment of the invention the liquid armature is a safety valve assembly with a safety valve arranged downstream of the outlet-side shut-off means.

A connection for an expansion tank can be provided at the second armature part of the safety valve assembly. If necessary an expansion tank may be connected. If no expansion tank is needed the connection can be closed in a simple way by means of a plug without having to change the armature.

Preferably the first shut-off means are formed by a ball valve, which can be moved between an open-position and a closed-position by means of a handle. The second shut-off means are formed by a ball valve which is provided with a coupling element for engaging a tool. The ball valve is adapted to be moved between the open-position and the closed-position, the handle of the first ball valve covering the coupling element of the second ball valve in the closed-position. In this embodiment the downstream ball valve can only be closed if the upstream ball valve is closed. For inspecting of a back flow preventer, for example, which is arranged in the second armature part, only the handle must be actuated. However, if the armature shall be dismantled, which occurs much less often, a tool is necessary to actuate the second ball valve.

In a further embodiment of the invention a, test plug in an opening is covered by the handle in its closed-position, the opening being connected to the volume upstream of a backflow preventer arranged in the second armature part. For the test of the backflow preventer the upstream shut-off valve is closed at first. Thereby the test plug is exposed. The test plug can then be removed and the test can be carried out.

In a preferred modification of the invention the second armature part is provided with a receiving opening for receiving a pressure reducer, said opening adapted to be closed by a plug. This is advantageous, because the pressure reducer can be inserted into the installation without changing the installation. There is no need for further shut-off means for servicing the pressure reducer, because the pressure reducer and the backflow preventer operate with the same shut-off means. The pressure reducer can be inserted cartridge-like in a receiving opening which is provided for this purpose. In installations, where there is a pressure reducer already present, the receiving opening is simply closed by a plug. Therefore, the armature part is suitable for installations which require a pressure reducer as well as for such installations where this is not the case.

Furthermore, a connection for an expansion tank adapted to be closed by a plug can be provided in the second armature part. Similar to the connection for the pressure reducer both cases—with and without an expansion tank—are covered with one armature. This simplifies the storage and the armature may be produced in larger numbers.

Preferably means are provided at said connection for the expansion tank for generating a flow in an expansion tank connected thereto. Thereby stagnant water in the expansion tank is avoided.

In a particularly preferred embodiment a high pressure tube is provided for connecting the expansion tank to the second armature part, said high pressure tube having two flow passages for flows in opposite directions. This is advantageous, because the bulky expansion tank can be arranged at any desired position around the armature. The pipe can run tightly along the wall or the like.

Preferably the connection for connecting the expansion tank is formed by a connection neck a flow guiding element being provided therein, extending into the flow path in the second armature part and guiding a portion of the liquid flowing through the second armature part through the expansion tank.

A backflow preventer can be provided in the second armature part and downstream from this backflow preventer a pressure gauge connection can be provided. Furthermore, an additional dirt trap can be arranged in the second armature part.

Further modifications of the invention are subject matter of the subclaims. Embodiments of the invention are described below in greater detail with reference to the accompanying drawings.

### THE DRAWINGS

In the accompanying drawings, which show the best mode currently contemplated for carrying out the invention:

FIG. 1 is a perspective view of a pipe disconnector assembly according to a first embodiment of the invention with an armature housing comprising a pipe disconnecter and a pressure reducer and a connection piece installed in the pipe, the axis of the essentially cylindrical armature housing running parallel in a distance from the axis of the pipe.

FIG. 2 shows a vertical sectional view of the armature housing and the connection piece of FIG. 1.

FIG. 3 shows a vertical sectional view of the pipe disconnector assembly with a connection piece and a downstream pressure reducer according to a second embodiment of the invention.

FIG. 4 shows a vertical sectional view of a safety valve assembly for a drinking water heater.

FIG. 5 is a perspective view of the ball of the ball valve of FIG. 4.

FIG. 6 is a top view onto the two ball valves in the assembly of FIG. 4 in an open-position.

FIG. 7 is a vertical sectional view of the ball valve with the ball of FIG. 5 in its open-position.

FIG. 8 is a horizontal sectional view along the line B-B in FIG. 6 cutting through the ball valve in its open-position.

FIG. 9 is a top view onto the two ball valves in the assembly of FIG. 4 in a partial closed-position.

FIG. 10 is a vertical sectional view of the ball valve with the ball of FIG. 5 in a partial closed-position.

FIG. 11 is a horizontal sectional view along the line B-B in FIG. 6 cutting through the ball valve in its partial closed position.

FIG. 12 shows a vertical sectional view of a safety valve assembly for a drinking water heater with pressure reducer.

FIG. 13 is a vertical sectional view of the safety valve assembly of FIG. 12 with an expansion tank directly connected thereto.

FIG. 14 shows a detail of FIG. 13 with the connection for the expansion tank.

FIG. 15 is a perspective view of a flow divider.

FIG. 16 is an exploded view of the flow divider of FIG. 15 on a star-shaped insert.

FIG. 17 is a cross sectional view of the connection of the flow divider of FIG. 15 and the star-shaped insert.

FIG. 18 is a vertical view of the connection of the expansion tank with a safety valve assembly by means of a high pressure tube.

FIG. 19 is an exploded view of the connection of FIG. 18.

FIG. 20 is a perspective view of an adapter for connecting a high pressure tube to a star-shaped insert.

FIG. 21 is a perspective view of a transition pipe for connecting a flow divider to a high pressure tube.

FIG. 22 is a vertical sectional view of a safety valve assembly with a dirt trap.

### DETAILED DESCRIPTION OF THE ILLUSTRATED EMBODIMENTS

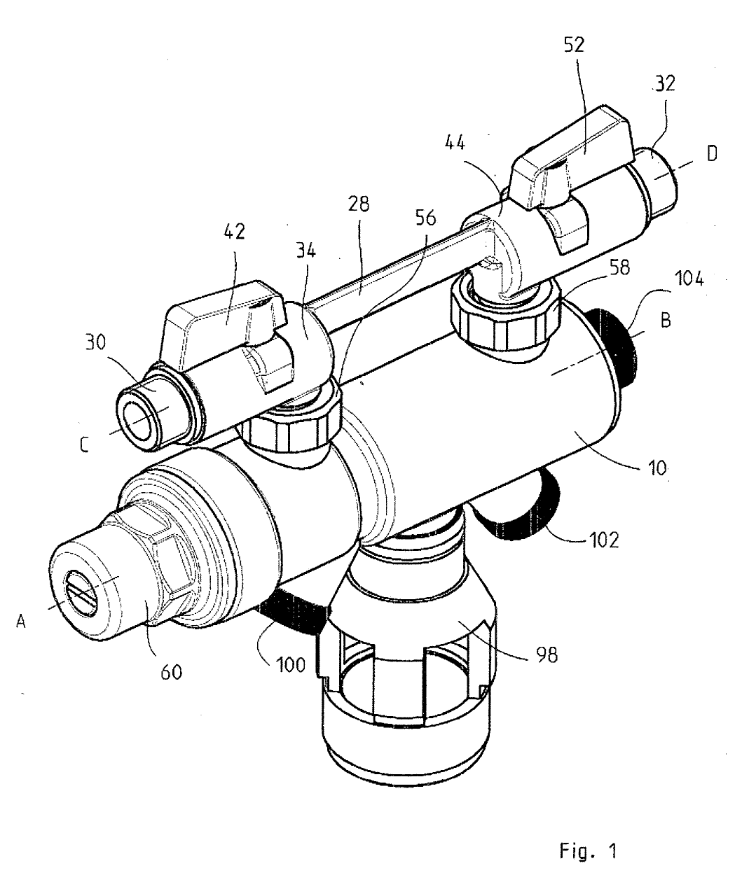

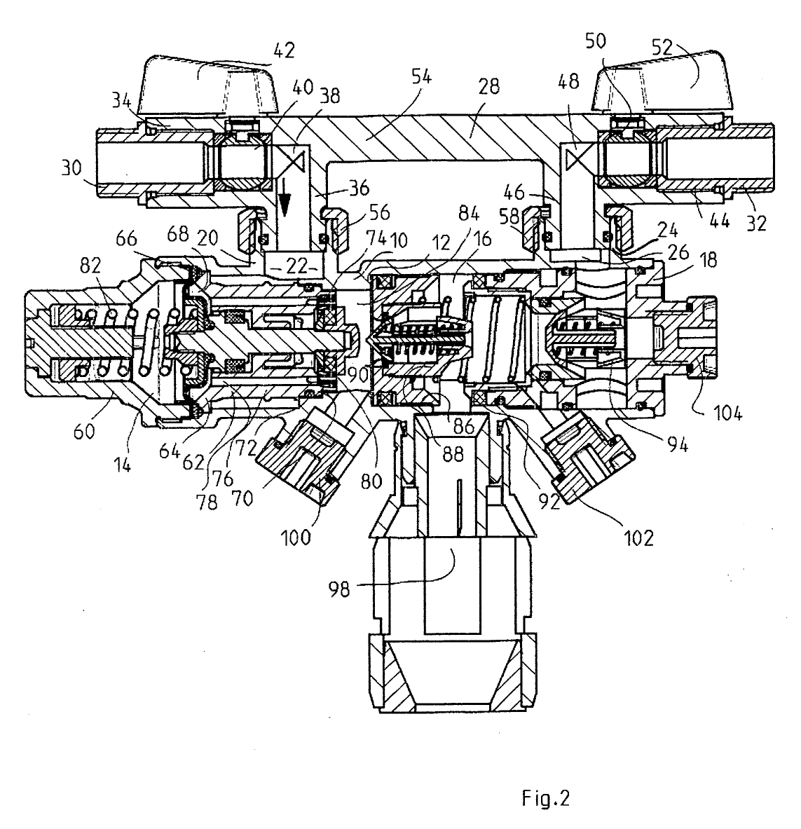

In FIGS. 1 and 2 numeral 10 denotes an armature housing with a cylindrical basic shape. As can be seen in FIG. 2 the armature housing is sleeve shaped and forms a shoulder 12. On the left side in FIG. 2 a pressure reducer 14 is screwed into the armature housing 10. The pressure reducer closes the bore hole of the armature housing on the left side in FIG. 2. The pressure reducer is a one-piece component which can be cartridge-like screwed into the armature housing 10. On the right hand side in FIG. 2 a pipe disconnector generally denoted by numeral 16 is inserted into the armature housing. The pipe disconnector 16 is provided with a carrier piece 18 closing the bore hole of the armature housing on the right side in FIG. 2.

The armature housing 10 is provided with an inlet sided connection neck 20 forming an inlet connection 22 and an outlet sided connection neck 24 forming an outlet connection 26. The connection necks 20 and 24 are arranged on the side of the armature housing 10 near its inlet sided and outlet sided end, respectively. They are parallel to each other and they are arranged on the same side of the armature housing. The cylindrical armature housing 10 defines a longitudinal axis. The axes of the connection necks 20 and 24 run perpendicular to this longitudinal axis and they lay in one plane, which is the paper plane of FIG. 2.

The armature housing with a pressure reducer 14 and a pipe disconnector 16 is installed into a pipe (not shown) by means of a connection piece 28. The connection piece 28 is provided with an inlet neck 30 and an outlet neck 32 aligned thereto. The inlet neck 30 is positioned in an inlet sided end piece 34 of the connection piece 28. A connection neck 36 is positioned at the end piece, the axis thereof running perpendicular to the axis of the pipe and the inlet- and outlet neck. The inlet neck 30, the end piece 34 and the connection neck 36 form an L-shaped inlet flow passage 38. A shut-off valve 40 in the form of a ball valve adapted to be operated by a handle 42 is positioned downstream or outlet sided of the inlet neck 30 in the inlet flow passage. The outlet neck 32 is positioned in an outlet sided end piece 44 of the connection piece 28. A connection neck 46 is positioned at the outlet sided end piece 44, the axis of this connection neck 46 running also perpendicular to the axis of the pipe and the inlet- and outlet neck and parallel to the axis of the connection neck 36. The outlet neck 32, the end piece 44 and the connection neck 46 form an L-shaped outlet flow passage 48. A shut-off valve 50 in the form of a ball valve adapted to be operated by a handle 52 is positioned upstream or inlet sided of the outlet neck 48 in the inlet flow passage. The inlet- and outlet sided end pieces 34 and 44, respectively, are connected to each other in a defined position by an integral distance piece 54. This distance piece does not carry a flow but only defines the respective position of the end pieces 34 and 44. The distance of the connection necks 36 and 46 of the connection piece 28 is the same as the distance of the connection necks 20 and 26 of the armature housing 10. The connection necks 20 and 24 of the armature housing 10 can, therefore, be connected to the connection necks 30 and 46, respectively, of the connection piece 26. This is effected by means of excentric screw connections 56 and 58, respectively, as it is described in DE 298 19 933 U. The connection necks 36 and 46 have the same length, so that their ends are positioned in the same plane. The Ends of the connection necks 20 and 24 are positioned in the same plane also. When the assembly is installed the longitudinal axis of the armature housing 10, therefore, runs distantly parallel to the axis of the pipe and the inlet and outlet neck 30 and 32 of the connection piece 28, as can be seen in the drawings.

Thereby the armature housing can be very easily mounted and de-mounted. The assembly and especially the armature housing 10 are simple and little space consuming. The armature housing 10 can be easily dismantled, exchanged or opened after closing the shut-off valves 40 and 50. The pressure reducer 14 is accessible from one side and the pipe disconnector 16 is accessible from the other side of the armature housing. The armature housing 10 can be inserted either in the way as shown or in a Position which is turned by an angle of 180° around the vertical axis in FIG. 2 and it can, thereby, be adapted to the flow direction in the pipe.

The pressure reducer 14 and the pipe disconnector are designed in a manner essentially well known to the person skilled in the art and, therefore, only briefly described.

The pressure reducer 14 is formed by an integrated assembly which is cartridge-like screwed into the open end on the left hand side in FIG. 2 of the sleeve like armature housing 10. The pressure reducer 14 is provided with a cap-like top part 60 and a bottom part 62. The bottom part 62 forms a cup-shaped part 64. A membrane 66 is clamped between the part 64 and the top part 60. A pressure chamber 68 is formed between the cup-shaped part 64 and the membrane 66. Furthermore, the bottom part has a sleeve-shaped valve seat body 70. The valve seat body 70 is tightly guided in the armature housing by means of a sealing ring 72. The valve seat body 70 forms a valve seat 74 of the control valve. The valve seat body 70 is connected to the cup-shaped part 74 by webs 76. Flow passages 78 run through the webs 76, which transfer the controlled pressure to the pressure chamber 68. The membrane 66 is connected to a valve plate 80 by a tappet. A helical spring 82 is positioned in the cap-like top part 60. The membrane is biased by the helical spring 82 from the left in FIG. 2, which is supported at the front surface of the cap 60.

The pressure in the chamber 84 downstream of the pressure reducer 14 pressurizes the membrane 66 in the opposite direction as the pressure by the helical screw 82. If the pressure in the chamber 84 exceeds a set value the membrane moves the valve plate towards the left in FIG. 2 and reduces the water flow so that the pressure in the chamber 84 is reduced. If a certain pressure in the chamber 84 is exceeded the control valve closes completely and independently of the inlet pressure. This provides an additional security against the backflow of liquid, for example service water from the outlet 26 to the inlet 22.

The pipe disconnector is provided with a sleeve shaped valve body 86. The valve body 86 is guided in the bore hole of the armature housing 10 and abuts the shoulder 12 in its idle position. A first upstream backflow preventer 88 is arranged in the valve body 86, the closing body of said valve body cooperating with a valve seat 90 of the valve body 86 and opening towards the outlet. A carrier part 18 is sealingly arranged in the right, open end of the armature housing 10 and closes the inner volume thereof on the right end in FIG. 2. The carrier part 18 forms a valve seat 92 in the form of a sealing ring. The valve body 86 cooperates with said valve seat. The valve body 86 is biased by a pressure spring, which is supported at the carrier part 18 and keeps the valve body in its idle position in abutment to the shoulder 12. A second, downstream backflow preventer 94 is arranged in the carrier part 18 cooperating with a valve seat arranged in the carrier part 18 and also opening in the direction of the outlet. The space 96 between the backflow preventers 88 and 94 is connected to an outlet 98.

In its idle position the relief valve formed by the valve body 86 and the valve seat 92 is open. Even in the case of a failing downstream backflow preventer 94 no service water or the like can enter the inlet side system, for example a fresh water system. Such service water would be outleted through the outlet 98. If there is a sufficiently high pressure at the inlet 22 the valve body 86 is moved towards the right in FIG. 2 into its closed position by the effect of the spring and abuts the valve seat 92. The relief valve is then closed. With a further pressure increase the backflow preventers 88 and 94 open, so that a liquid flow can occur from the inlet 22 to the outlet 26.

A test connection 100 adapted to be closed is connected to the space between the pressure reducer 14 and the pipe disconnector 16. A further closable test connection 102 is connected to the medium pressure chamber between the backflow preventers 88 and 94. The two test connections 100 and 102 are arranged at the armature housing 10 with an angle on both sides of the outlet 98. A third test connection 104 is connected to the outlet 26. This test connection 104 is arranged at the front side of the carrier part 18.

Instead of one uniform connection piece 28 the armature housing could also be connected by two separate connecting means at the inlet 22 and outlet 26, corresponding to, for example, the end pieces 34 and 44, respectively.

### Embodiment 2: Pipe Disconnector with Downstream Pressure Reducer

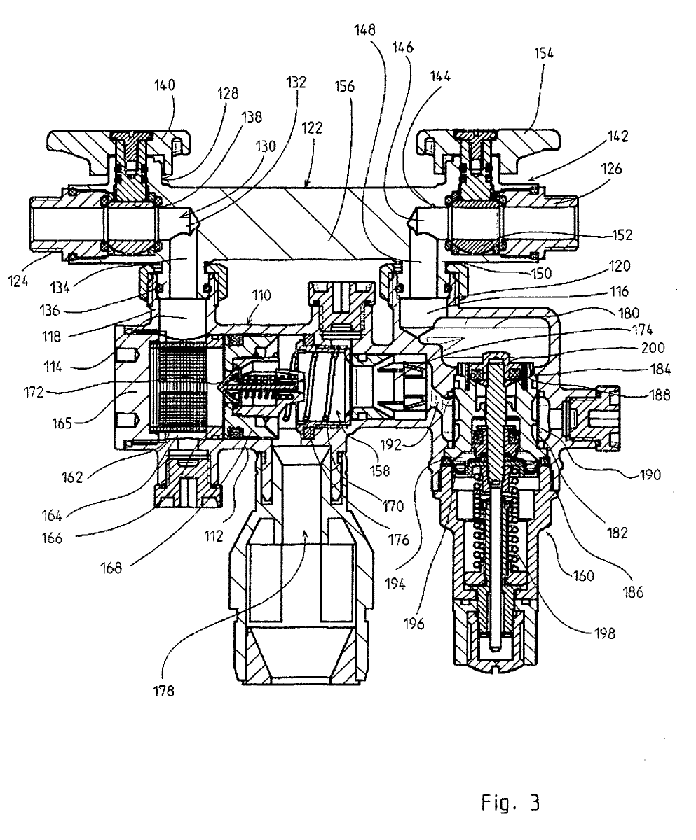

In FIG. 3 numeral 110 denotes an armature housing. The armature housing 110 is elongated and forms a sleeve-shaped jacket part 112. An inlet 114 and an outlet 116 are distantly provided at the armature housing 110. Inlet 114 and outlet 116 are provided at the side of the armature housing 110 and connected to connection necks 118 and 120, respectively. The connection necks 118 and 120 run perpendicular to the longitudinal axis of the jacket part 112 in the drawing plane of the Figure. The connection necks 118 and 120 end in a common connection plane which is perpendicular to the drawing plane of the figure and parallel to the longitudinal axis.

For connecting the armature housing a connection piece 122 is provided. The connection piece 122 has an inlet neck 124 and an outlet neck 126 aligned thereto. The connection piece 122 is installed into a liquid pipe (not shown) with these inlet- and outlet necks 124 and 126, respectively. This liquid pipe is connected to a supply system, for example a drinking water system on the inlet side and to, for example, a warm water heating system.

The inlet neck 124 is arranged at an inlet sided end part 128. The end part 128 forms an inlet flow passage 130. A section 132 of the inlet flow passage 130 ending in the inlet neck 124 runs in the longitudinal direction of the connection piece 122. A section 134 perpendicularly branches off the section 132. The section 134 ends in a connection neck 136. The connection neck 136 is connected to the inlet side connection neck 118 of the armature housing 110. A shut-off valve 138 in the form of a ball valve is arranged in the inlet side end piece 128. The shut-off valve 138 can be operated by means of a rotating handle 140. The outlet neck 126 is arranged at an outlet side end piece 142. The end piece 142 forms an outlet flow passage 144. A section of the outlet flow passage 144 ending in the outlet neck 126 runs in the longitudinal direction of the connection piece 122. A section 148 perpendicularly branches off the section 146. The section 148 ends in a connection neck 150. The connection neck 150 is connected to the outlet side connection neck 120 of the armature housing 110. A shut-off valve 152 in the form of a ball valve is arranged in the outlet side end piece 142. The shut-off valve 152 can be operated by means of a rotating handle 154. The two end parts 128 and 142 are connected to each other by a distance piece 156. The distance piece 156 has a size allowing the connection necks 136 and 150 of the connection piece 122 to be in alignment with the connection necks 118 and 120, respectively, of the armature housing.

A pipe disconnector, generally denoted by numeral 158, is positioned on the inlet side, i.e. on the left in the figure, in the armature housing 110. A pressure reducer 160 is arranged on the outlet side, i.e. on the right in the figure. The liquid, therefore, flows from the supply system through the inlet side end piece 128 through the pipe disconnector 158 and the pressure reducer 160 to the outlet side end piece 142. The pressure reducer 160, thereby, directly controls the outlet pressure and thereby the pressure in the downstream system, for example a warm water heating system.

A dirt trap 162 is arranged on the inlet side of the pipe disconnector 158. For this purpose the sleeve-shaped jacket part 112 of the armature housing 110 is closed by a plug on its inlet side end, said plug carrying the cylindrical dirt trap 162 on an inner surface. The armature housing 110 forms an inlet chamber 164 upstream to the pipe disconnector 158, which is connected to the inlet 114. The cylindrical dirt trap 162 on one side limited by the front surface of the plug 165 extends into the inlet chamber 164. With its free end the dirt trap 162 abuts an annular surface 166 which is stationary with respect to the housing, the liquid flow flowing from the inlet 114 through the jacket surface and the open front surface of the dirt trap 162 to the pipe disconnector 158.

The pipe disconnector 158 is designed similar to the embodiment according to FIG. 1 having an outlet valve 168 biased in the opening direction by a spring 170, an upstream backflow preventer 172 positioned in the valve closing body of the outlet valve and a downstream backflow preventer 174. The valve closing body of the outlet valve cooperates with a valve seat 176. The outlet valve 168 is put into its closed position by the inlet pressure against the effect of the spring 170. The backflow preventers 172 and 174 then open in the direction from the inlet 114 to the outlet 116. If the inlet pressure decreases or the medium pressure between the backflow preventers 172 and 174 increases above the inlet pressure the outlet valve opens and establishes a connection to the outlet 178. Thereby a physical separation of the warm water heating system (or the like) and the supply system is automatically generated.

The armature housing 110 defines an outlet chamber 180 downstream of the pipe disconnector 158, the outlet chamber being connected to the outlet 116. On its side opposite to the outlet 116 the outlet chamber 180 is connected to a receiving hole 182 for the pressure reducer 160 formed in the armature housing 110. The pressure reducer 160 is formed as an integrated, cartridge-like component inserted into the receiving hole 182.

The design of the pressure reducer 160 is conventional and mainly corresponds to the pressure reducer according to the embodiments of FIGS. 1 and 2.

The receiving hole 182 comprises a separating wall 184 with a recess next to the outlet chamber 180. Furthermore the receiving hole 182 comprises a receiving neck 186. The pressure reducer 160 is inserted into the receiving neck 186, the pressure reducer being positioned on a shoulder on the inside of the receiving neck 186 on one end and on the other end being positioned tightly in the recess in the separating wall 184 with an integrated valve seat 188. An annular space 190 is formed between the shoulder and the separating wall around the pressure reducer 160, said annular space being connected to the exit 192 of the pipe disconnector 158. The pressure reducer 160 defines a control pressure chamber 194 limited by a control membrane 196. The control pressure chamber is connected to the outlet 116. The control membrane is biased by a biasing spring 198. The control membrane controls a valve plate 200 cooperating with the valve seat 188 and forming a control valve.

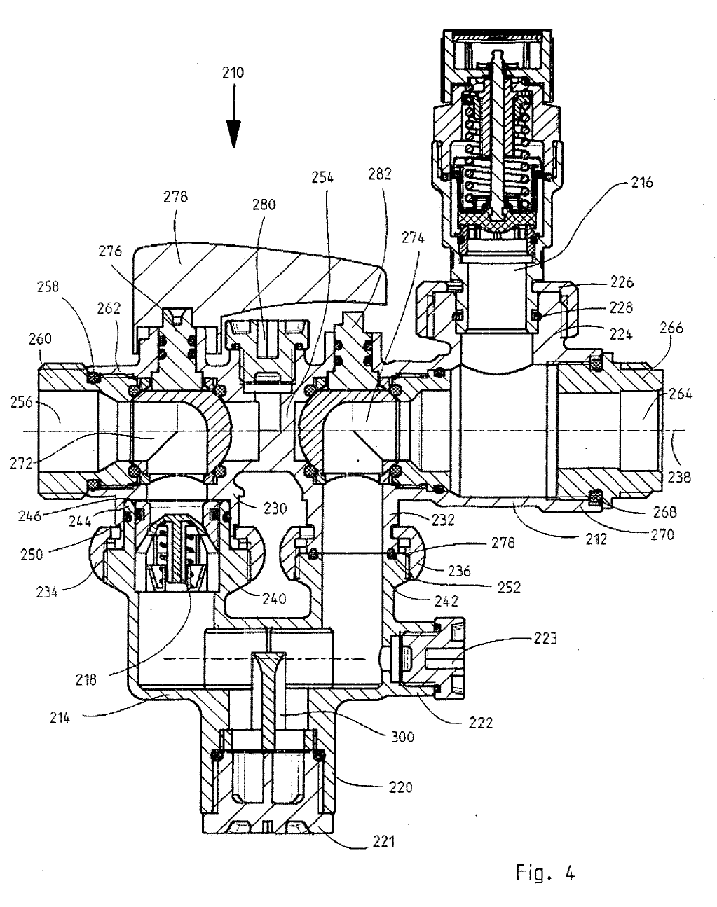

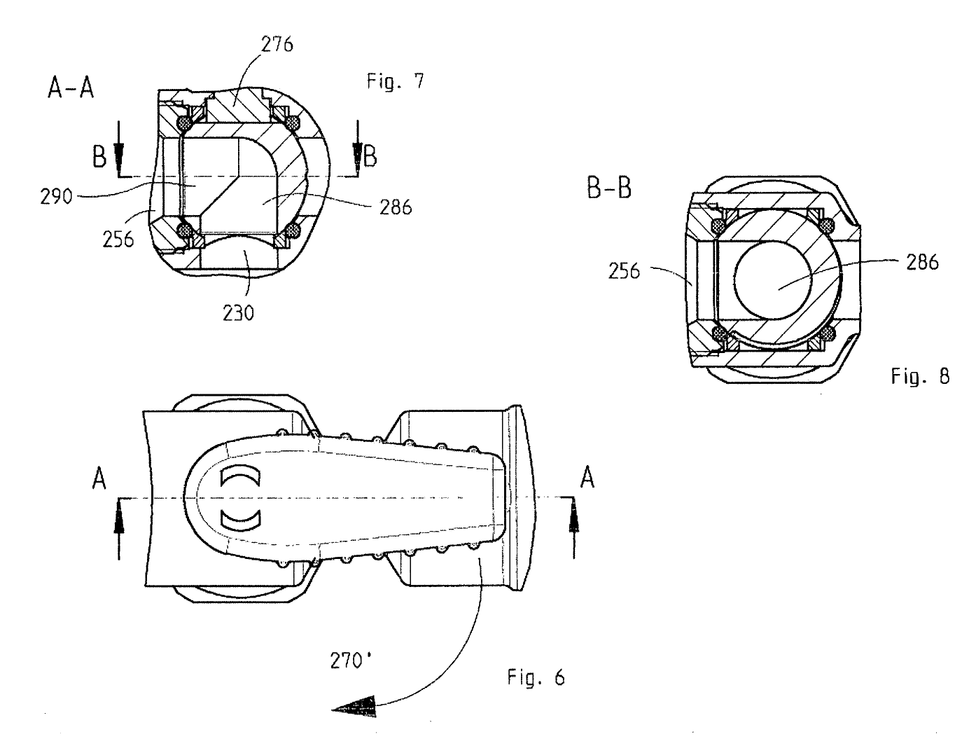

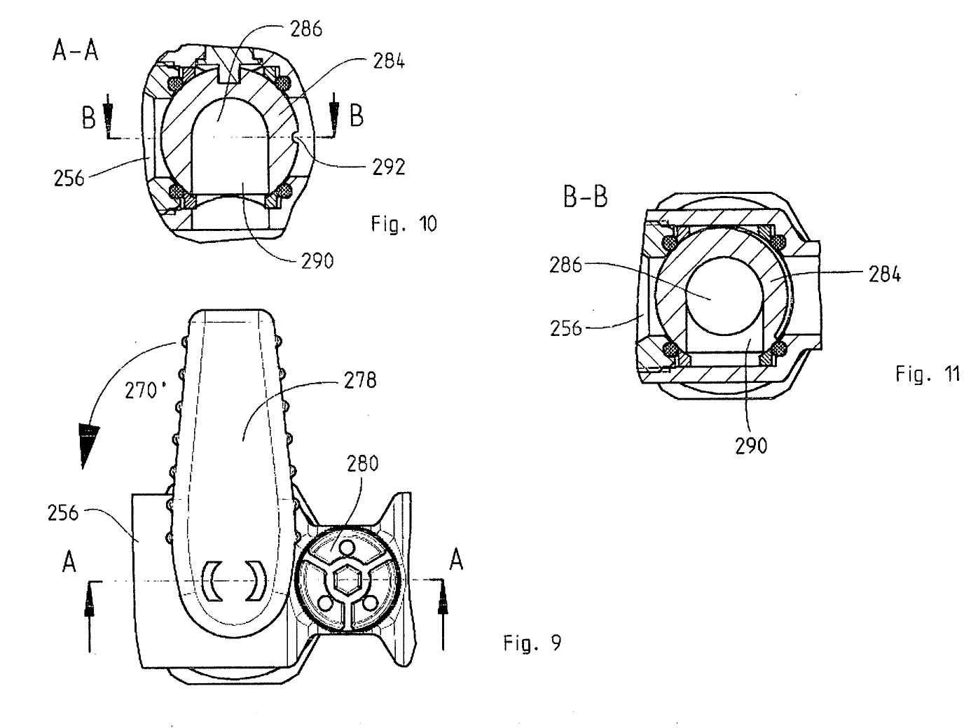

### Embodiment 3: Safety Valve Assembly Without a Pressure Reducer (FIGS. 4-11)

In FIG. 4 a safety valve assembly is shown which is generally denoted by numeral 210. The safety valve assembly 210 comprises a two-part armature with a first armature part 212 fixedly installed in a pipe (not shown) and a removable second armature part 214. A safety valve assembly is provided at the armature part 212.

A backflow preventer 218 is provided at the removable armature part 214. The backflow preventer 218 is arranged in such a way, that it opens downwards in FIG. 4 and blocks an upwardly in FIG. 4 directed backflow. Apart from that the backflow preventer has a common design.

Furthermore a connection neck 220 for an expansion tank is provided at the removable armature part 214. There is no expansion tank installed in the present embodiment. The connection neck 220 is, therefore, closed with a plug 221.

A pressure gauge can be connected at a further connection neck 222. The connection neck 222 is closed with a plug 223 which is removed for measuring.

The fixedly armature part 212 is essentially longitudinally formed and is provided with a connection neck 224 for the safety valve assembly 216. The safety valve assembly 216 is screwed onto the neck 224 by means of a union nut 226. A sealing ring 228 seals the connection between the safety valve assembly 216 and the neck 224. The safety valve is a commonly used, adjustable membrane safety valve with connection screws. It is, therefore, not necessary to describe it here in detail. The safety valve opens if the pressure in the assembly exceeds a given value. The water is then outleted through an outlet.

For connecting the fixedly installed armature part 212 with the removable armature part 214 two connection necks 230 and 232 are provided at the fixedly installed armature part 212. The connection necks are parallel to each other. There central axes extend perpendicular to the longitudinal axis 238 of the fixedly installed armature part 212. The removable armature part 214 has two corresponding necks 240 and 242. The armature parts 212 and 214 are connected to each other at their necks 230, 232, 240 and 242 by means of nuts. The screwed connection is an excenter-screw-connection and it is the same as it is described in great detail in the DE 298 19 933.5 U.

For connecting the removable armature part the neck 240 is inserted into the neck 230 until its upper end in FIG. 4 abuts the shoulder 246 of the armature part 214. The upper end 248 in FIG. 4 of the neck 242 then abuts the lower outer edge of the neck 232. Sealing rings 250 and 252 are provided at the connections.

A connection part 260 with sealing rings 258 is screwed into the inlet neck 262 at the inlet side end 256 of the armature part 212. A connection part 266 with sealing rings 268 is screwed into the outlet neck 270 at the outlet side end of the armature part 212.

The water flows from the inlet 260 from the direction of the flow out of the pipe, around the corner through the ball 272 of the open ball valve to the neck 230. From there it flows into the second armature part 214, at the entrance of which the backflow preventer 218 is positioned. The water flows from the second armature part 214 through the neck 242 back to the neck 232 of the first armature part 212. There is the open ball 274 of the second ball valve. The direction of the flow changes again and runs in the direction of the outlet 264.

By closing the ball valves 272 and 274 the connection to the pipe can be shut off in a very easy way. The second armature part can then be removed. For this purpose the screws are loosened and the second armature part 214 is pulled off. It is then easily accessible and can be replaced or serviced.

If the backflow preventer must be inspected the ball valve 272 is closed. For this purpose the ball is rotated by means of the actuating element 276 with a handle. Thereby the flowpath between the inlet 256 and backflow preventer 218 is interrupted. By removing the plug 280 closing an opening, which is connected to the space between the backflow preventer 218 and the ball valve 272 it can be inspected whether the backflow preventer 218 is in good working order.

The plug 280 is covered by the handle 278 if the ball valve 272 is opened. It is only accessible, if the handle is rotated, i.e. if the ball valve 272 is closed. Thereby the removing of the plug is difficult if the valve is opened, so that the unintentional opening at full pressure is avoided. Furthermore, the handle 278 is designed such that it also covers a coupling element 282. The ball valve 274 can be opened and closed with this coupling element 282 by using for example a wrench. Similarly to the test plug 280 the closing of the outlet side ball valve 274 is difficult if the ball valve 272 is opened.

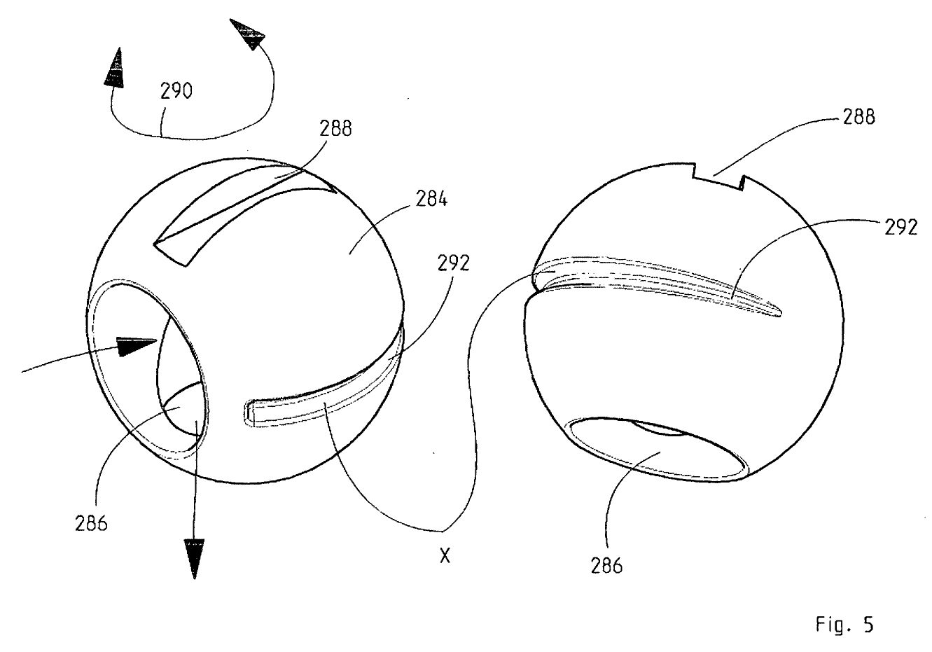

The ball valve 272 is designed in such a way, that a rotation of the handle about an angle of 270° instead of the usual 90° is necessary to completely close the ball valve. Thereby an often occurring pressure shock on the valve during closing is reduced. This is explained in greater detail with reference to FIGS. 5 to 11.

In FIG. 5 the ball 284 of the ball valve 272 is separately shown in detail. The ball 284 has a flow passage 286 which is bent by an angle of 90°. If the flow passage 286 connects the inlet 256 to the neck 230 the ball valve is in an open position. The ball is provided with a recess 288 a coupling element 276 being engaged therein (FIG. 4). Thereby the ball can be rotated, as it is indicated by the double-arrow 290. In FIGS. 6-8 this open position is shown. The handle fixedly connected to the coupling element 276 is in the position as it is shown in FIG. 6, where the test plug 280 is covered.

If the ball 284 is now at first rotated by an angle of 90° with the handle 278, the inlet side opening 290 of the flow passage 286 is moved sideways. Thereby the flow passage 286 is gradually closed. In common ball valves the flow passage is then completely closed and a pressure shock is generated due to this closing procedure. In FIGS. 9 to 11 the ball valve is shown in a position after a rotation by 270°.

In the present embodiment the ball 284 has a circumferential groove 292. The circumferential groove 292 is connected to the flow passage 286. The cross section of the circumferential groove 292 becomes smaller with increasing distance from the inlet side opening 290 of the flow passage 286. In the present embodiment the groove extends in a plane which is perpendicular to the rotational axis of the ball 284, however, the groove could also run along a different plane forming an angle with the rotational axis of the ball 284.

A portion of the water can still flow through the groove 292 into the flow passage 286 when the ball valve 272 is closed and from there further even if the inlet side opening of the flow passage 286 is completely closed. However, the further the ball is rotated the smaller becomes the cross section of the groove 292 and the smaller becomes the flowing amount. If the ball has carried out a rotation by 270° no water can flow through the groove 292. Only then the ball valve is completely closed.

In the present embodiment the ball closes the valve 272 only after a rotation by 270 and the pressure shock is essentially reduced.

### Embodiment 4: Safety Valve Assembly with Pressure Reducer

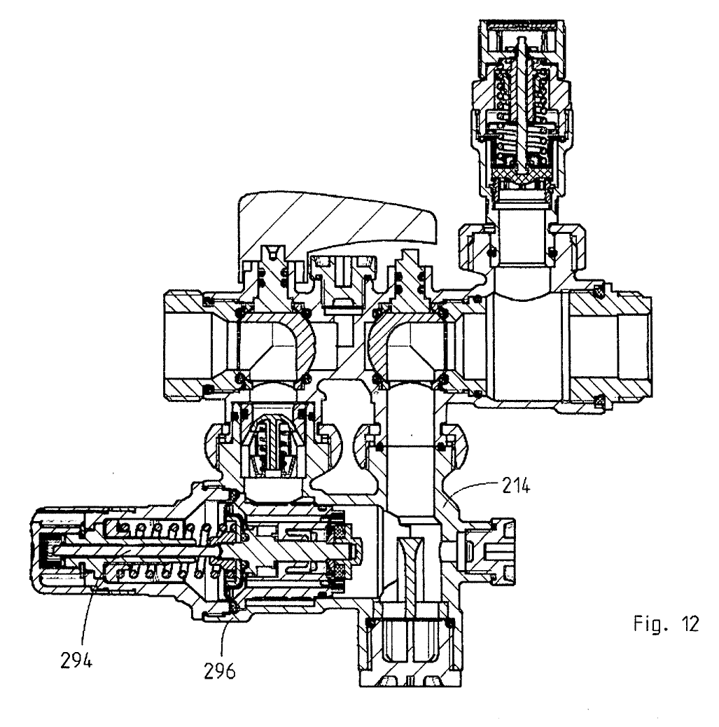

In FIG. 12 an embodiment is shown being a modification of the safety assembly according to FIGS. 4 to 11. Here a pressure reducer 294 is integrated into the assembly. Apart from that the assembly is not changed with respect to the assembly of FIG. 4. For connecting the pressure reducer 294 a connection neck 296 is provided in the second armature part 214. The pressure reducer 294 is cartridge-like inserted into the armature part 214 through the connection neck 296. Such a cartridge-like pressure reducer is already known and need not be described here in further detail.

The pressure reducer 294 is arranged in the removable armature part 214 downstream of the backflow preventer 218. In the case of a need of service the pressure reducer can be removed or replaced or serviced just like the backflow preventer 218 as described above. It is a particular advantage that the installation size with the additional pressure reducer does not change compared to the installation size of an assembly without a pressure reducer as shown in FIG. 4. An assembly with a pressure reducer can, therefore, be installed without any further do into the existing assembly. The second armature part only has to be removed and modified accordingly. The pipe remains unchanged.

In the case, that a pressure reducer is not needed or a pressure reducer is present at another place the neck 296 may as well be closed by a plug.

### Embodiment 5: Safety Valve Assembly with Pressure Reducer and Expansion Tank

A safety valve assembly with an expansion tank is described with reference to the following figures, which is apart from that identical to the safety valve assembly of embodiment 4.

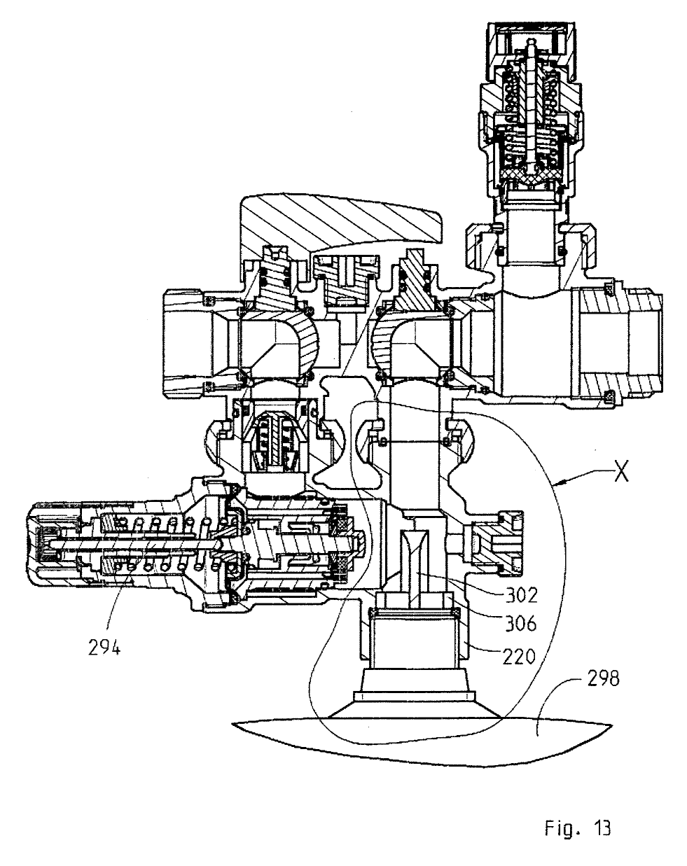

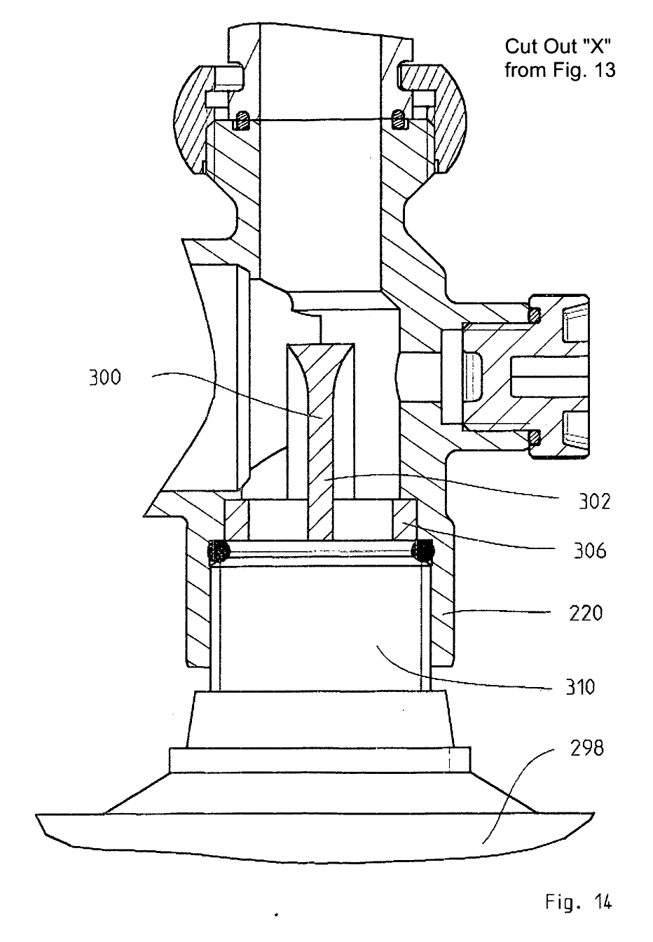

In FIG. 13 a complete safety valve assembly is shown. The safety valve assembly is provided with an expansion tank 298 with a common design at the neck 220 The expansion tank 298 is only partly indicated. A pressure reducer 294 is arranged upstream of the expansion tank 298. The inlet pressure of the installation is kept at a constant value by the pressure reducer 294. The expansion tank then has its maximum receiving volume. In installations where there is a pressure reducer present at a different position anyway or where the pressure is not very high, this pressure reducer is not needed. The connection is then closed with a plug.

For avoiding stagnant water in the expansion tank it is advantageous to generate a flow. For this purpose an assembly is provided which is described in greater detail with reference to FIG. 14.

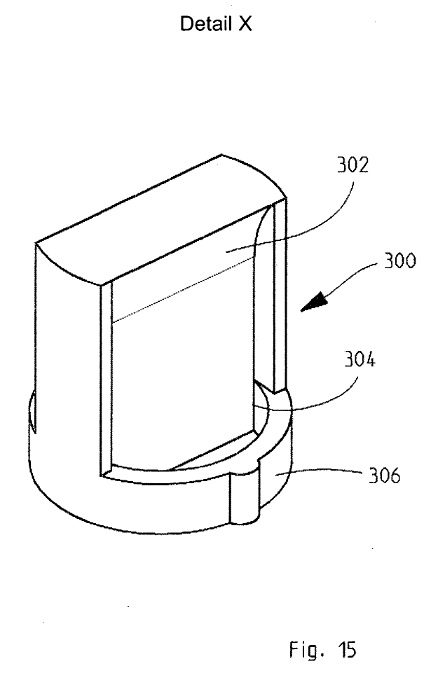

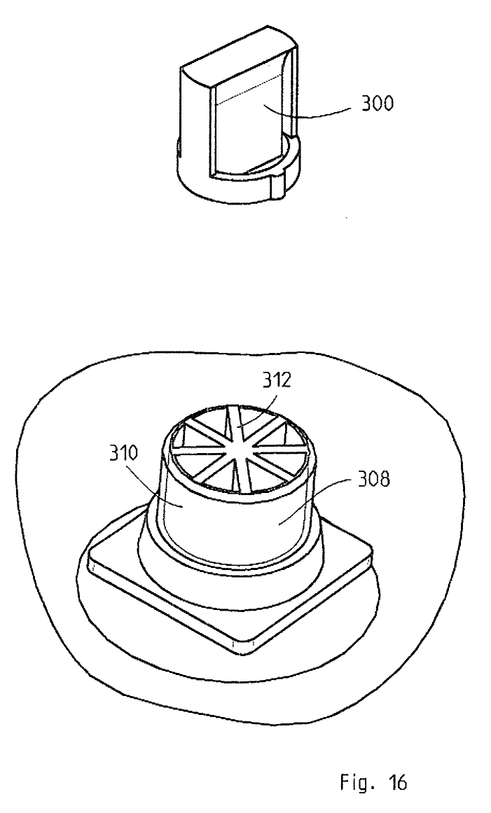

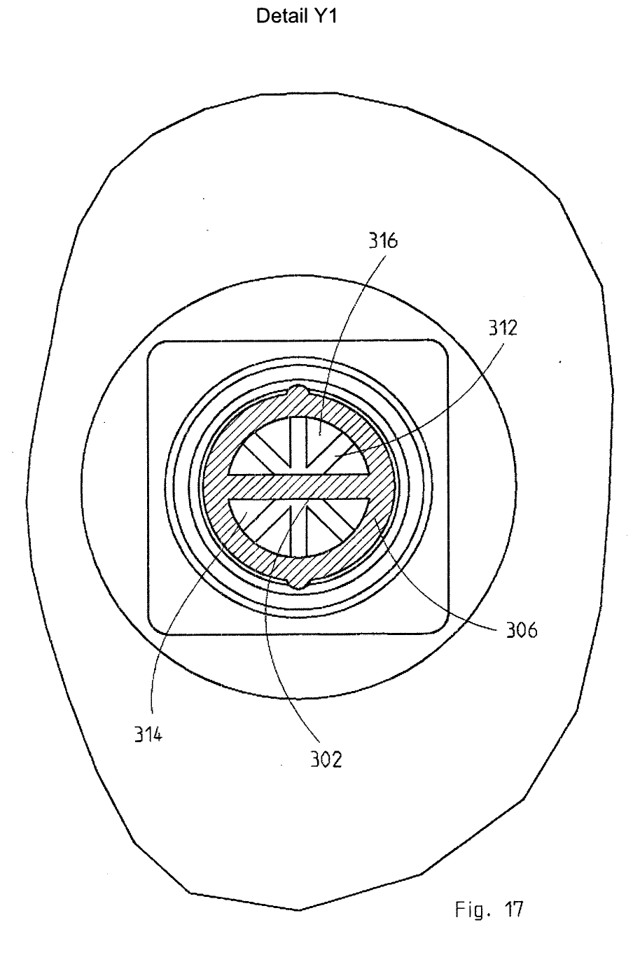

The flow in the expansion tank 298 is generated by means of a flow divider 300. It causes a portion of the flow being guided through the expansion tank. In FIG. 15 the flow divider is perspectively shown. The upper part 302 of the flow divider is formed by an element extending into the second armature part 214 perpendicular to the flow. It is connected to a ring 306 at its lower edge 304. The flow divider 300 is inserted on a star insert 308 with the ring 306. This is shown in the exploded view of FIG. 16. The star insert 308 has a cylindrical jacket 310 with star-shaped webs 312 arranged therein. The webs extend along the entire height of the jacket 310. The upper portion 302 of the flow divider 300 is wide enough to always completely cover two webs 312 regardless of the angular insertion position of the flow divider 300 on the star insert. This can be easily seen in the view in FIG. 17. The flow, therefore, flows through a first portion 314 of the star insert into the expansion tank and through the opposite portion 316 back out of it. In such a way a sufficient flow is generated in the expansion tank.

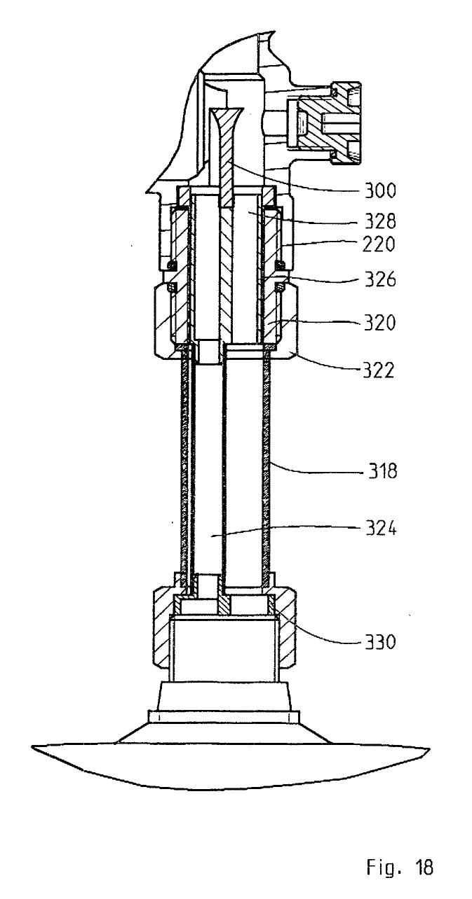

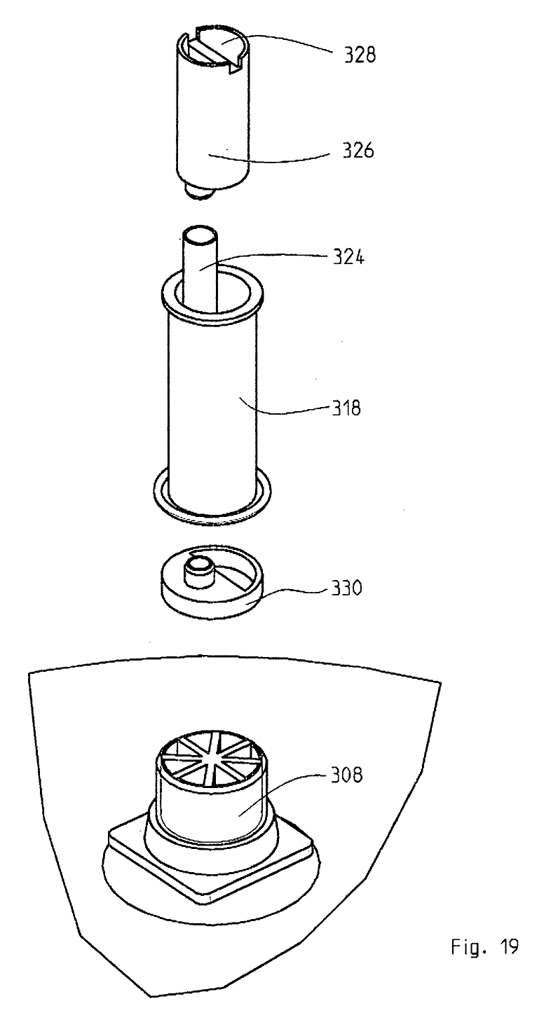

In FIGS. 18 and 19 a modification of the safety valve assembly is shown. In this modification the expansion tank is not directly connected to the neck 220 but using a flexible high pressure tube. Thereby the very bulky expansion tank can be fixed at various places also, which are not immediately next to the armature.

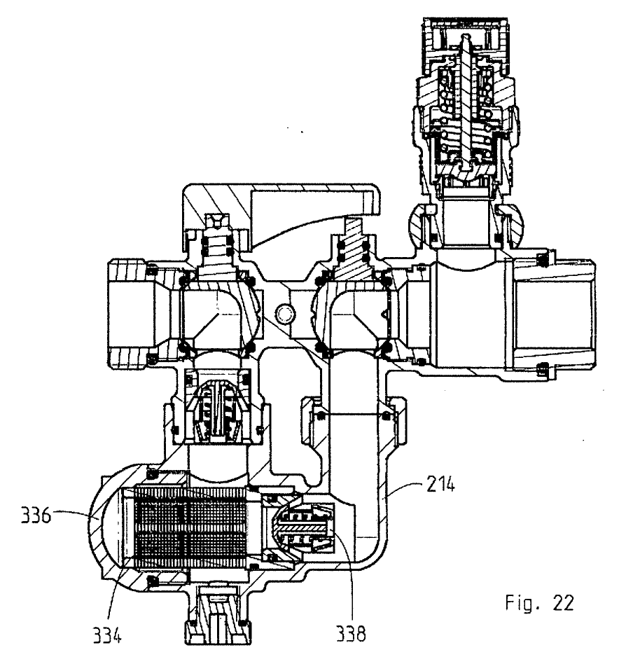

A high pressure tube 318 is connected with a connection piece 320 by means of a nut 322 to the connection neck 220. A pipe 324 is provided in the high pressure tube. The flow divider 300 is not directly inserted in the star insert 308, but on a transition pipe 326. The transition pipe 326 is shown in FIG. 21 in greater detail. At its upper end 328 the inner volume of the transition pipe 326 is divided into to halves with a semicircular cross section. Along the length of the pipe this cross section changes from one of the halves into a smaller circle 329 while the cross section remains the same. The such generated halfcylindric volume 331 is connected to the high pressure tube. The remaining volume is connected to the flexible pipe 324 arranged in the high pressure tube 318.

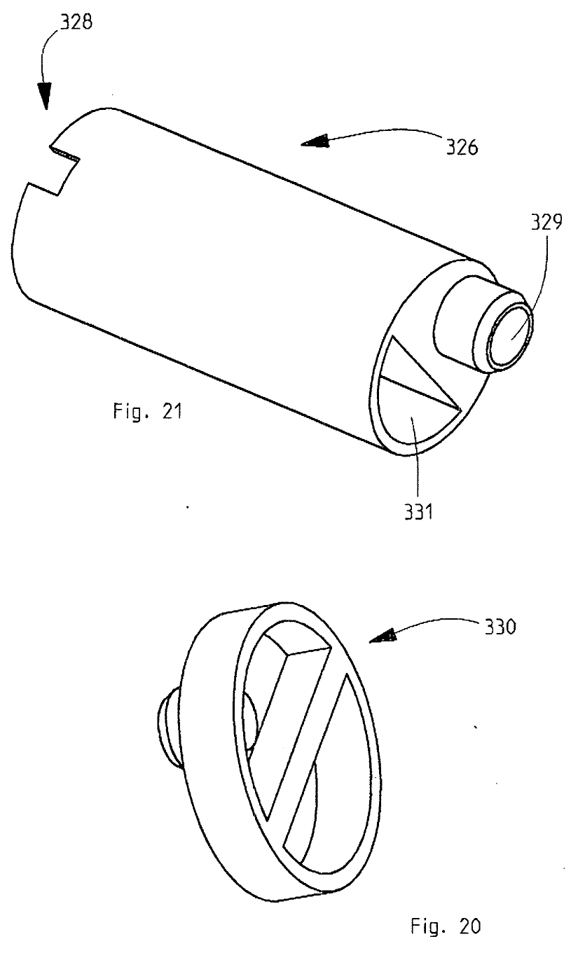

The tube 318 and the pipe 324 are connected to the star insert 308 at the other end by means of an adapter 330. The adapter 330 is shown in FIG. 20 in greater detail. The lower side has an identical cross section as the lower side of the flow divider 300. The star insert is accordingly the same as the star insert, that is used without the high pressure tube.

The expansion tank can be fixed almost at any desired position with this modification.

### Embodiment 6: Safely Valve Assembly with Dirt Trap

In an alternative, particularly simple embodiment there is a dirt trap 334 arranged upstream to the backflow preventer 338 in the second armature part 214. The dirt trap has a transparent cap 336 so that it can be recognized from the outside whether cleaning is necessary.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

I claim:

1. A fitting assembly for liquids adapted to be installed in a pipeline comprising an inlet and first shut-off means governing said inlet, an outlet and second shut-off means governing said outlet, and components which require occasional or regular servicing, said components being arranged in a flow path between said first and second shut-off means, wherein
said fitting assembly comprises a first fitting part adapted to be fixedly installed in said pipeline by means of said first and second shut-off means,
said first fitting part having first and second connecting means between said first and second shut-off means,
said fitting assembly comprises a second fitting part, said second fitting part containing said components which require occasional or regular servicing, and
a means for removably attaching said second fitting part to said connecting means of said first fitting part.

2. A fitting assembly as claimed in claim 1, wherein said connecting means comprise two connecting sockets, the axes of which are parallel.

3. A fitting assembly as claimed in claim 2, wherein said inlet and outlet are in alignment, whereby a longitudinal fitting axis is defined, said axes of said connecting sockets being perpendicular to said longitudinal fitting axis.

4. A fitting assembly as claimed in claim 1, wherein said shut-off means are ball valves with flow passages therethrough.

5. A fitting assembly as claimed in claim 2, wherein
said shut-off means are ball valves,
said ball valves comprise angled flow passages therethrough having upstream legs and downstream legs,
the upstream leg of the flow passage of the ball valve of said first shut-off means, in its open position, being aligned with said inlet, and the downstream leg of the flow passage of the ball valve of said first shut-off means being aligned with an upstream one of said connecting sockets, and
the upstream leg of the flow passage the ball valve of said second shut-off means, in its open position, being aligned with a downstream one of said connecting sockets, and the downstream leg of the flow passage of the ball valve of said second shut-off means being aligned with said outlet,
whereby, in said open positions of said ball valves, liquid flows from said inlet through said angled flow passage of said ball valve of said first shut-off means, through said upstrean connecting socket, through said first fitting part, through said downstream connecting socket and through said angled flow passage of said ball valve of said second shut-off valve to said outlet, while, in their closed positions, said ball valves shut off communication between said inlet and said upstream connecting socket or between said downstream connecting socket and said outlet, respectively.

6. A fitting assembly as claimed in claim 4, wherein said ball valve of said first shut-off means is rotatable about an axis of rotation through an angle of at least 180° between its open and closed positions.

7. A fitting assembly as claimed in claim 4, wherein said ball valve of said first shut-off means is rotatable about an axis of rotation through an angle of at least 270° between its open and closed positions.

8. A fitting assembly as claimed in claim 6, wherein said ball valve of said first shut-off means has a valve ball with a circumferential groove, said circumferential groove communicating with said flow passage of said ball valve and with said upstream connecting socket and establishing communication between said flow passage and said connecting socket even after direct communication is shut-off due to the ball valve being rotated out of its open position, the cross section of said circumferential groove decreasing along the circumference to gradually reduce the liquid flow therethrough to zero, when the ball valve approaches its closed position.

9. A fitting assembly as claimed in claim 1, wherein said second fitting part comprises a pressure reducer.

10. A fitting assembly as claimed in claim 1, wherein said second fitting part comprises a dirt trap or filter.

11. A fitting assembly as claimed in claim 1, wherein said first fitting part comprises one or more backflow preventers.

12. A fitting assembly as claimed in claim 2, wherein said connecting sockets are connected to said second fitting part by means of nuts having inner diameters larger than the outer diameters of said connecting sockets, said nuts, during assembly of said second fitting part and said connecting sockets being eccentric with respect to the connection axis.

13. A fitting assembly as claimed in claim 1 forming a pipe disconnector assembly for preventing backflow of liquid from said outlet to said inlet by pressure-dependent physical separation of flow connection between said inlet and said outlet.

14. A fitting assembly as claimed in claim 13, wherein said pipe disconnector comprises an upstream and a downstream backflow preventer and a pressure controlled relief valve therebetween

15. A fitting assembly as claimed in claim 13, wherein said first fitting part comprises
an upstream connection and valve unit with an inlet socket forming said inlet, a connecting socket for connection with said upstream connecting socket of said second fitting part and a shut-off valve forming said first shut-off means intermediate said inlet socket and said connecting socket,
a downstream connection and valve unit with a connecting socket for connection with said downstream connecting socket of said second fitting part, an outlet socket forming said outlet, said outlet socket being aligned with said inlet socket, said inlet and outlet sockets defining a longitudinal axis of said first connecting part, and
a spacer between said upstream and downstream connection and valve units.

16. A fitting assembly as claimed in claim 15 and further comprising a shut-off valve forming said second shut-off means intermediate said connecting socket and said outlet socket.

17. A fitting assembly as claimed in claim 13, wherein
said second fitting part is elongated and defines a longitudinal axis,
said longitudinal axis of said second fitting part is parallel to and spaced from said longitudinal axis of said first fitting part.

18. A fitting assembly as claimed in claim 14, wherein said second fitting part includes a pressure reducer, in addition to said pipe disconnector.

19. A fitting assembly as claimed in claim 18, wherein said second fitting part has three test ports provided with closing means, a first one of said test ports communicating with a space defined between said pressure reducer and said pipe disconnector, a second one of said test ports communicating with a space defined between said second shut-off valve and said downstream backflow preventer, and a third one of said test ports communicating with a space upstream of said downstream backflow preventer.

20. A fitting assembly as claimed in claim 17, wherein said third test port is positioned on the front side of said second fitting part.

21. A fitting assembly as claimed in claim 13, wherein
said second fitting part has a sleeve-shaped jacket portion defining a cavity with aligned first and second open ends,
a pressure reducer is sealingly inserted into said cavity through a first one of said open ends, said pressure reducer forming a contiguous, cartridge-like insert, and said first open end of said cavity is closed by a sealingly inserted closure part, and
said pipe disconnector is sealingly inserted into said cavity through a second one of said open ends, said second open end being sealingly closed by a carrier part of said pipe disconnector.

22. A fitting assembly as claimed in claim 21, wherein said pressure reducer and said pipe disconnector are removable for servicing purposes by pulling them out of said cavity through said first or second open ends, respectively.

23. A fitting assembly as claimed in claim 22, wherein said first open end is the inlet-side end of the cavity, and the second open end is the outlet-side end of the cavity.

24. A fitting assembly as claimed in claim 18, wherein in said second fitting part said pressure reducer is arranged downstream of pipe disconnector.

25. A fitting assembly as claimed in claim 10, wherein said dirt trap or filter is arranged on the inlet side of a pipe disconnector.

26. A fitting assembly as claimed in claim 10, wherein
said second fitting part comprises a sleeve-shaped jacket portion defining a cavity open at the inlet-side end, said cavity being closed by a plug at the inlet-side end,
said dirt trap or filter is a hollow cylinder arranged adjacent said plug and covering the passage between said first fitting part and said cavity.

27. A fitting assembly as claimed in claim 26, wherein
said cavity accommodates a pipe disconnector, an inlet chamber being defined upstream of said pipe disconnector,
said inlet chamber communicating with said inlet through said first connecting means,
said cylindrical dirt trap or filter engages the inner end face of said plug, extends into said inlet chamber and engages an annular shoulder surrounding said cavity, whereby liquid flows from the inlet through the cylindrical dirt trap or filter and the open inner end of said dirt trap or filter to said pipe disconnector.

28. A fitting assembly as claimed in claim 27, wherein
an outlet chamber is defined in said cavity downstream of said pipe disconnector, said outlet chamber being connected on one side to said outlet of said first fitting part,
said cavity defining an accommodation recess for a pressure reducer,
said pressure reducer forming a contiguous, cartridge-like insert sealingly inserted into said accommodation recess.

29. A fitting assembly as claimed in claim 1, wherein said second fitting part comprises a safety relief valve assembly arranged downstream of said outlet-side, first shut-off means.

30. A fitting assembly as claimed in claim 29, wherein
said first shut-off means comprise a first ball valve and handle means for rotating said first ball valve about a first axis of rotation between an open position and a closed position,
said second shut-off means comprise a second ball valve adapted to be rotated about a second axis of rotation between an open position and a closed position, and a coupling means to be engaged by a tool for rotating said second ball valve,
said handle means of said first ball valve covering said coupling means of said second ball valve, when said first ball valve is in its closed position.

31. A fitting assembly as claimed in claim 30, wherein
said second fitting part comprises a backflow preventer,
said first fitting part has a test port between said first and second axes of rotation, said test port being closed by a plug and communicating with a space upstream of said backflow preventer,
said plug of said test port being covered by said handle means, when said first ball valve is in its closed position.

32. A fitting assembly as claimed in claim 31, wherein said second fitting part has an accommodating cavity for accommodating a pressure reducer.

33. A fitting assembly as claimed in claim 1, having connecting means for connecting an expansion tank to said second fitting part.

34. A fitting assembly as claimed in claim 33, wherein said connecting means for connecting said expansion tank are provided on said second fitting part.

35. A fitting assembly as claimed in claim 34, wherein said connecting means comprise means for generating liquid flow through an expansion tank connected thereby.

36. A fitting assembly as claimed in claim 35, wherein
said connecting means for connecting said expansion tank to said second fitting part comprise a high pressure hose or tube defining two flow passages permitting liquid flow therethrough in opposite directions.

37. A fitting assembly as claimed in claim 36, wherein
said connecting means for connecting said expansion tank comprise a connecting socket,
said connecting socket containing a flow guiding element, which extends into the path of the liquid flow flowing through said second fitting part,
said flow guiding means guiding part of the liquid which flows through said second fitting part through said expansion tank.

38. A fitting assembly as claimed in claim 37, wherein said flow guiding means comprise a flow divider extending flag-like into said flow path.
